(19) United States
(12) Patent Application Publication
(10) Pub. No.: US 2007/0012017 A1
(43) Pub. Date: Jan. 18, 2007

(54) Machine for edging lawn grass

(76) Inventor: Jacob Blotsky, Fargo, ND (US)

Correspondence Address: David D. Winters, Suite 237, 2277-C Wilma Rudolph Blvd., Clarksville, TN, 37040-5898, US

(21) Appl. No.: 11/180,414

(22) Filed: Jul. 13, 2005

(51) Int. Cl. A01D 34/42

(52) U.S. Cl. 56/251

(57) ABSTRACT

A machine for edging a lawn with an adjustable cutting blade on a support bracket configured to attach to a body of a lawnmower at a point proximate to the point of attachment of a front wheel of the lawnmower.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of lawn care and more specifically to a machine for edging a sodded lawn.

In gardens, lawns, or other locations where sodded areas abut non-sodded areas or structures such as flower beds, walks, stepping stones, or the like, it has long been noted that a neatly and uniformly trimmed edge to the sodded areas gives a more pleasurable appearance to said abutments. Thus, a large number of devices have been contrived to affect such edges with maximum possible ease.

U.S. Pat. No. 117,485 by Tournier discloses a device in the form of a wheelbarrow which cuts an edge of a lawn by means of a circular knife attached next to a wheel on one side and on the same axis as said wheel and said circular knife being mounted on a shaft. The radius of the circular blade is larger than the radius of the wheel so that the maximum depth of cut is the difference between the radius of the wheel and the radius of the circular blade. Tournier also teaches extra rollers attached to either side of the device near the shaft whereon are mounted the circular knife and the wheel, said rollers being movable from an inoperative position to a position wherein said rollers will extend downward farther than the downward extension of the circular knife so that the device may be rolled over a surface without cutting it. Tournier also teaches a storage area for tools one may need in the course of an edging operation and a means of adding sufficient weight to the device to facilitate penetration of the lawn.

U.S. Pat. No. 4,200,155 by Mullet et al teaches a lawn edging attachment for power driven vehicles consisting of a spinning disk blade carried by an arm for rotation with power means provided to pivot said arm.

U.S. Pat. No. 3,489,225 by Bass teaches a lawn edging device requiring a U shaped adapter bracket hingedly mounted with a blade such that it adjustably swings in and out, toward and from the associated lawn mower side wall. The herein taught art includes none of these limitations. Additionally, the art as taught by Bass, is, because of the clearance required by its athwartships swinging characteristic, inherently incapable of being mounted near a lawnmower wheel or inside the cutting radius of the lawnmower blade. Thus, the grass being edged cannot be efficiently dispersed by the lawnmower blade(s). This limitation is, in contrast, avoided by the herein taught art.

U.S. Pat. No. 3,003,301 by Koon teaches an edging attachment for a lawn mower that, in contrast to the herein taught art, demands a mounting bracket with an L shaped section, permanently connected to the housing of a mower, and supporting a slide plate and swivel plate for radial adjustment of the cutting blade. It specifies that the cutting blade must be locked into place using circumferential adjustment slots with thumb-nuts and a shield is required to cover the cutting edge of the blade. The herein taught technology requires none of the above limitations.

U.S. Pat. No. 3,231,024 by Lazich teaches an edging attachment for a lawn mower said attachment comprising a first means for grooving and a second means for clipping grass. The first grooving means is secured to a wall of the lawn mower by means of two brackets. The first grooving means comprises a blade, said blade fixed in either of two positions by a stop pin and a pair of abutments. The second means for clipping grass comprises a rotary edging attachment.

U.S. Pat. No. 2,691,823 by Dombrowski discloses a device to cut an annular portion of sod, only.

U.S. Pat. No. 5,065,567 by Wessel et al discloses an edging device comprising an edging disc rotatably mounted to a plate slidably mounted in a receiver channel said receiver channel being secured to an axle of a lawn mower said axle supporting a wheel. The disk is movable in a vertical and linear direction between stored and operative positions. A slide plate latch extends upwardly above the disk and mower deck where it can be grasped, moved outwardly to unlatch the disk and then pushed downward to move the disk to an operable position. The disk may be removed for close in mowing. The device is mounted adjacent to the distal side of the wheel from the lawn mower body.

U.S. Pat. No. 4,551,967 by Murcko teaches an edging device attached to a powered lawn mower, said edging. device having. a spinning blade powered by the mower engine.

U.S. Pat. No. 6,810,647 B1 by Evrikoz discloses a powered lawn edging device wherein edging is achieved by the action of rotating wires.

Tournier teaches an edging device having a circular blade. The position of the circular blade taught by Tournier cannot be adjusted relative to the frame of the device so that if the device is to be moved over a surface that should not be cut, auxiliary wheels must be deployed. In addition, the Tournier art does not provide for grass cutting and edging to be accomplished contemporaneously by means of the same device or combination.

In substantial contrast to Tournier, the instant technology teaches a non-circular blade.

In additional contrast to Tournier, the instant art describes a device having adjustability of the blade relative to the remainder of the device such that a cutting depth may be adjusted and the blade may be retracted for moving without cutting. In yet further contrast to Tournier, the instant disclosure teaches grass cutting contemporaneous with edging and is, thus, an improvement over Tournier.

Mullet et al disclose a lawn edging attachment for a lawnmower, said attachment affecting edging by means of a circular blade. Furthermore, said circular blade is attached to the body of the lawnmower and can be raised and lowered by a complicated contrivance of numerous elements cunningly constructed to function in concert.

In contrast to Mullet et al, the instant art teaches a non-circular blade mounted on a simple hinge connection. The instant disclosure is more simple having substantially fewer parts than the Mullet et al taught art. Thus, the instant art is cheaper to manufacture, more simple to assemble, easier to install, and less complicated to use, an improvement over Mullet et al.

Bass discloses an edging and trimming device for attachment to the exterior peripheral surface of the usual housing of a power driven lawnmower. Bass teaches a bar member comprising a blade, said bar member held by a two-part bracket, the first part being attached to the exterior peripheral surface of the usual housing of a power driven lawn mover and supporting a second part on which the bar member is operatively mounted. Furthermore, the Bass art requires that the exterior peripheral surface of the lawn mower housing be modified by having a bolt hole drilled in it in order to affect mountability of the two-part bracket. In addition, for the Bass disclosure to perform in the manner described, the two-part bracket must be mounted at a point on the exterior peripheral surface of the usual housing of a power driven lawn mower at a maximum distance from the longitudinal axis of said housing since the usual housing of a power driven lawn mower is annular and the direction of the cut made by the Bass device is parallel to the direction the attached power mower moves.

In contrast to Bass, the instant disclosure teaches no two-part bracket. Also in contrast to Bass, the instant disclosure is configured to be compatible with the existing features of the lawn mower and without modification of the lawn mower to which it is to be attached. Furthermore, in additional contrast to Bass, the instant art teaches mountability of a lawn edging device on a mower between a wheel of the mower and the body of the mower. A cutting element of the instant disclosure is thus nearer the longitudinal axis of the mower housing than a cutting element of the Bass art so that in the example of the instant art, force or energy is more efficiently transferred from the motive force of the mower to the cutting element in the instant art than in the Bass art. The instant disclosure is therefore an improvement over Bass.

In yet additional contrast to Bass, because the cutting element of the instant technology edges grass in advance of the cutting blade of the associated mower and within the cutting radius of said mower, the instant technology allows action of the mower blade to affect disintegration and dispersal of the edged grass clippings. The Bass device, being positioned outside the cutting radius of the mower with which it communicates, accrues no such advantage. The instant art thus affects additional improvement over Bass.

In yet further contrast to Bass, the instant disclosure does not extend beyond the original lateral dimensions of the mower with which said instant disclosure communicates so that the space needed for passage of a mower adapted by the instant art is smaller than the space needed for. passage of a mower adapted by the Bass art. Since virtually all mowing jobs require some cutting of grass in tight spaces, the instant art is further improvement over Bass.

Koon teaches a power mower edging attachment comprising a side plate, a swivel plate, links, an arm, and a shield. In substantial contrast, the instant disclosure teaches no side plate, swivel plate, arm, links, or shield. Furthermore, since the instant art is less complex than Koon, said instant art can be manufactured, assembled, and deployed with greater economy of labor and material, an improvement over Koon.

Lazich discloses a two-part edging attachment comprising a sod grooving element and a hand operated rotary edging element. Furthermore, Lazich teaches a mounting bracket assembly for a knife blade said assembly comprising an L-shaped bracket, and a Z-shaped bracket. In addition, Lazich teaches a blade having only one operative position.

In contrast to Lazich, the present art teaches no multi part bracket assembly, no additional rotary edging assembly, and a plurality of possible operative positions for a cutting blade. Additionally, the instant disclosure is much more simple than Lazich so the instant disclosure can, therefore, be manufactured, assembled, and deployed with greater economy of labor and material than Lazich. The instant art is thus an improvement over Lazich.

Dombrowski teaches a hand operated device designed only for use by itself for cutting and removing an annular portion of sod. In substantial contrast, the instant art teaches use in association with a mowing device and cutting non-annular portions of sod.

Wessel et al teach a lawn edging attachment comprising a disk on the wheel axle of a lawn mower said disk mounted to a slide plate in a receiver channel, said receiver channel secured to the axle of a lawn mower, said receiver channel being secured proximate the wheel side distal from the body of the lawn mower. The Wessel art further comprises a slide plate latch whereby the disk, slide. plate, and latch may be removed to accommodate mowing close to obstructions. In contrast, the instant art teaches a blade rather than a disk. Furthermore, the instant disclosure teaches no slide plate.

In further contrast to Wessel et al, the instant disclosure teaches attachment proximate the wheel side nearer the body of the mower. Therefore, the instant art requires no removal of an edging assembly from the lawn mower in order to facilitate mowing close to obstructions. Thus, the instant art is an improvement over Wessel et al.

Murcko teaches a combination lawn mower and edging attachment having an edging blade powered to affect edging by means of rotation of said edging blade. In substantial contrast to Murcko, the instant disclosure teaches no power blade nor rotating blade.

Evrikoz teaches a lawn mower, trimming, and edging system, whereby, trimming edging, and mowing are accomplished by means of rotatable wires. In contrast to Evrikoz, the instant disclosure teaches a blade with no part of the instant art requiring rotation in an operative mode.

### BRIEF SUMMARY OF THE INVENTION

The primary object of the invention is to provide a simplified edging or trimming attachment for a lawnmower.

Another object of the invention is to provide an edging or trimming attachment for a lawnmower said edging or trimming attachment being easily installable by a layman.

Another object of the invention is to provide a simplified edging or trimming attachment said edging or trimming attachment being easily and cheaply manufactured.

A further object of the invention is to provide a simplified edging or trimming attachment for a lawnmower, whereby, the weight of the lawnmower facilitates penetration of sod by the edging blade.

Yet another object of the invention is to provide a simplified edging or trimming attachment for a lawnmower, whereby, the inertia of the moving lawnmower facilitates the passing through of sod by the edging blade.

Still yet another object of the invention is to provide a simplified edging or trimming attachment for a lawnmower, wherein, said simplified edging or trimming attachment may be positioned in a non-operative position while the lawnmower operates in its conventional fashion.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a machine for edging lawn grass comprising: a blade support bracket configured to attach to a body of a lawnmower at a point proximate to the point of attachment of a front wheel of the lawnmower by means of any of the same hardware used to attach said front wheel to said body of the lawnmower and by means of any of the same holes or hole in the body of the lawnmower said blade support bracket also configured to connectively receive the edging blade, a configured to be adjustably attached to the blade support bracket, and a pin or pins to attach the blade to the blade support bracket.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a top perspective view of a blade support bracket.

FIG. 2 is a top perspective view of a blade.

FIG. 3 is a partial top perspective view of an edging assembly of a blade support bracket with blade attached.

FIG. 4 is a side perspective view of the assembly in FIG. 3 exploded.

FIG. 5 is a top perspective view of an alternate embodiment of a blade support bracket.

FIG. 6 is a top perspective view of the alternate embodiment of the blade support bracket in FIG. 5 with a blade inserted.

FIG. 7 is a side perspective of a mower and the edging assembly showing the position of the mounted edging assembly relative to the mower.

FIG. 8 is an exploded top perspective view showing a lawn mower wheel assembly communicating with a blade support bracket and a lawn mower housing wall.

FIG. 9 is a side view of a lawn mower with an edger blade assembly attached.

List of components

| | |
|---|---|
| 10 | Blade support bracket |
| 20 | Blade |
| 25 | Pin |
| 30 | Cotter clip |
| 35 | Cotter clip hole |
| 40 | Mower body attachment hole |
| 45 | Blade attachment hole |
| 55 | Blade support sleeve |
| 60 | Blade support channel |
| 65 | Cutting edge |
| 70 | Mower |
| 75 | Mower wheel |
| 85 | Edge of blade support bracket |
| 90 | Mower housing wall |
| 95 | Sodded sward |
| 98 | Forward direction |
| 100 | Lawn mower |
| 105 | Lawn mower wheel mounting assembly |
| 110 | Bolt |
| 115 | Nut |
| 120 | Lawn mower wheel mounting assembly holes |
| 125 | Edger blade assembly |
| 130 | Bolt holes |

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the. present invention in virtually any appropriately detailed system, structure or manner.

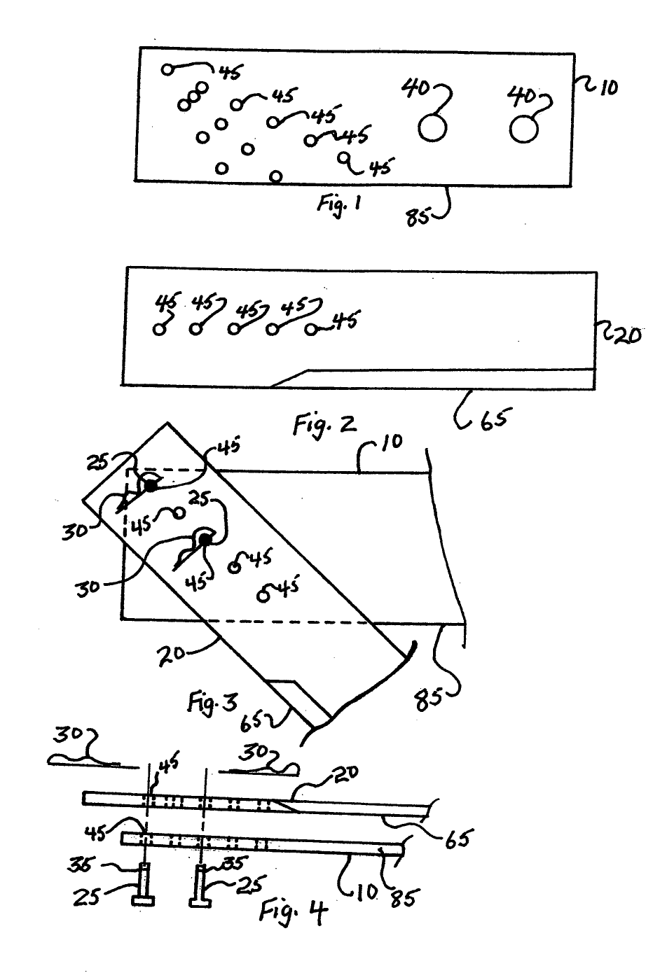

Turning first to FIG. 1 and FIG. 2 we see a blade support bracket (10) having a first end and a second end with first end comprising mower body attachment holes (40) whereby the blade support bracket (10) may be attached to the body of a lawn mower. It is to be understood that since the usual lawnmower has wheel assemblies that are bolted onto the body of the lawn mower through holes in said body, it is possible, by configuring the mower body attachment holes (40) to correspond with the wheel assembly mounting holes in the lawn mower body, to contrive the blade support bracket to be attached to the lawnmower body through the same holes and utilizing the same connective devices as used to attach the wheel assembly. It is to be further understood that since different brands or models mowers may have different wheel assembly mounting configurations or means, additional mower body attachment holes (40) may be added in order to configure the blade support bracket (10) so that said blade support bracket (10) may be attached to a variety of different brands or models of mowers. Additionally, it is possible that different blade support brackets (10) be configured for each particular brand or model of mower.

Looking further at FIG. 1 and FIG. 2 we also see the second end of the blade support bracket comprising rows of blade attachment holes (45) said rows of blade attachment holes (45) comprising different angles from the edges (85) of the blade support bracket (10) each said row of blade attachment holes (45) running both laterally and longitudinally across the second end of the blade support bracket (10).

In addition, we see a blade (20), said blade (20) having a first end and a second end with said first end having a row of blade attachment holes (45). running along the center longitudinal axis of the blade (20). We also see along a longitudinal edge of the second end of the blade (20) a cutting edge (65).

Looking now at FIG. 3 and FIG. 4, we see that the blade support bracket (10) and the blade (20) may be positioned so that the row of blade attachment holes (45) on the blade (20) will correspond to one of the rows of blade attachment holes (45) on the blade support bracket (10). We further see that pins (25) may be inserted through said corresponding holes (45) in the blade (20) and blade support bracket (10) and that cotter clips (30) may be inserted through cotter clip holes (35) in the pins (25) so the pins (25) will tend to stay in position thus rigidly holding the blade support bracket (10) and the blade (20) together at a constant angle. It is also to be understood that the angle of the blade support bracket (10) and the blade (20) may be varied by aligning the blade attachment holes in the blade (20) with a different row of blade attachment holes (45) in the blade attachment bracket (10). It is to be further understood that the distance the first end of the blade (20) extends beyond one of the edges (85) of the blade support bracket (10) may be varied by differing the particular blade attachment holes (45) aligned between the blade (20) and the blade attachment bracket (10). Thus, the blade (20) is adjustably attached to the blade support bracket (10).

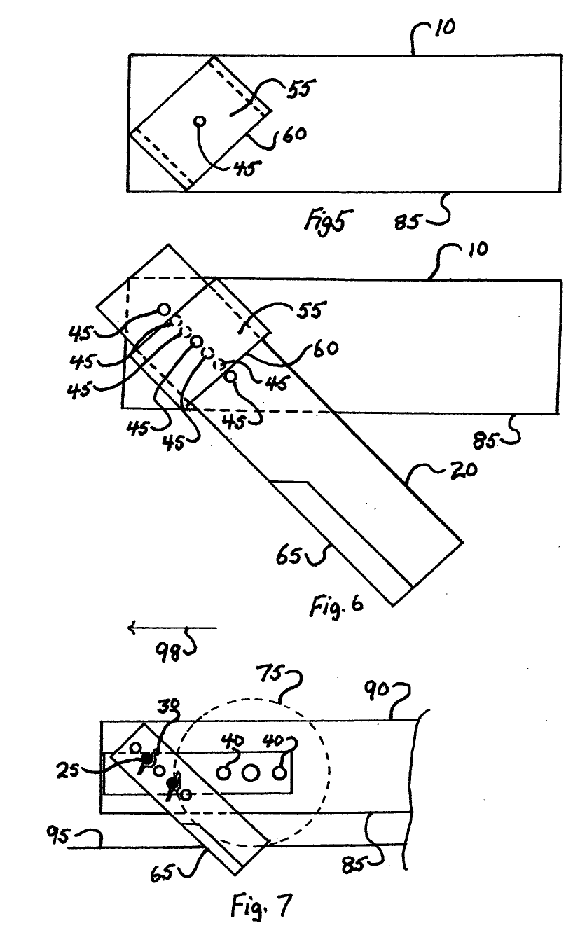

Turning now to FIG. 5 and FIG. 6, we see an alternate embodiment of the blade support bracket (10), wherein, the first end of the blade support bracket (10) comprises a blade support sleeve (55) and a blade support channel (60). We also see corresponding blade attachment holes (45) in the blade support sleeve (55) and the blade support bracket (10) said holes (45) being positioned so that when the first end of a blade (20) is inserted into the blade support channel (60), a blade attachment hole (45) in the blade may be caused to correspond with the blade attachment holes in the blade support sleeve (55) and the blade support bracket (10). We can thus understand that by fixing a pin (25) in a manner previously described in place through said corresponding holes, the blade (20) will be held in a fixed position relative to the blade support bracket (10).

Looking now at FIG. 7, we see the front portion of a mower housing wall (90) having a lawn mower wheel (75) (shown by dotted line) attached. We also see a blade support bracket (10) attached to the mower housing wall (90) at a point proximate the mower wheel by means of mower body attachment holes (40) which correspond to the same holes used to attach the mower wheel (75) to the mower housing wall (90), and we understand that the same hardware originally used to attach the mower wheel (75) to the mower housing wall (90) may at the same time also be used to attach the blade support bracket (10) to the mower housing wall (90).

We see, in addition, a blade (20) attached to the blade support bracket by means of pins (25) through corresponding blade attachment holes (45) in the blade (20) and the blade support bracket (10), said pins (25) held in place by cotter clips (30). We see that the cutting edge (65) of the blade (20) extends below the level of the sodded sward (95) having been forced there by the weight of the mower so that when the mower is pushed in a forward direction (98), the blade (20) will cut the sodded sward (95). The inertia of the lawnmower will assist in pushing the blade (20) through the sodded sward (95). The cut grass is then drawn under the mower where the moving blade chops and disperses it or directs it to a cutting bag. Therefore, we see that the presently taught machine when connectively attached to a mower may be used to perform an edging operation in the manner of an edger.

Furthermore, because the distance the blade (20) extends beyond the edge (85) of the blade support bracket (10) is variable as previously described, said distance may be adjusted so that the blade (10) does not contact the sodded sward (95). Thus, the blade (10) may be moved to an inoperative position for mowing without edging, or for moving the lawn mower over any surface not desired to be cut by the blade (10).

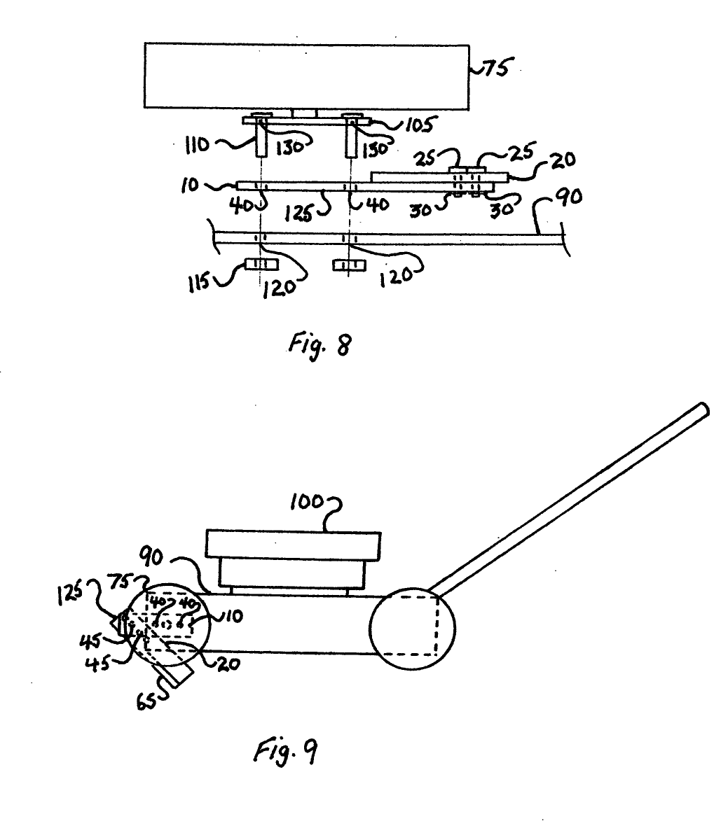

Looking now at FIG. 8, we see a lawn mower wheel (75) attached to a lawn mower wheel mounting assembly (105) having bolts (110) inserted through bolt holes (130). In addition, we also see an edger blade assembly (125) having a blade support bracket (10) having mower body attachment holes (40) said holes (40) aligning with the bolt holes (130), and we also see a lawn mower housing wall (90) having lawn mower wheel mounting assembly holes (120) said lawn mower assembly mounting holes (120) aligning with the mower body attachment holes (40) and the bolt holes (130). We see further that bolts (110) may be inserted through said aligned holes (130), (40), and (120) so that by tightening nuts (115) on the ends of said bolts (110) extending through said holes (130), (40), and (120), the edger blade assembly (125) and the lawn mower wheel mounting assembly (105) may be attached to a lawn mower housing wall (90) using the same attachment means.

Looking now at FIG. 9, we see a side perspective view showing the relative operative positions of a lawn mower (100) and an edger blade assembly (125) communicating in a preferred embodiment.

While the invention has been described in connection with a preferred embodiment, it is not intended to limit the scope of the invention to the particular form set forth. But on the contrary, is intended to cover such alternatives, modifications, and equivalents as may be included within the spirit and scope of the invention as defined by the appended claims.

What is claimed is:

1. A machine for edging lawn grass comprising:
a blade support bracket;
a means to attach the blade support bracket to a lawn mower;
a blade extending beyond an edge of the blade support bracket when said blade is attached to the blade support bracket; and
a means to attach the blade to the blade support bracket.

2. A machine as in claim 1, wherein, the blade support bracket is mounted on a movable platform.

3. A machine as in claim 1, wherein, the blade support bracket is attached to an associated lawn mower at its wheel and axle assembly by incorporating the means of mounting said wheel and axle assembly as the means of mounting the blade support bracket.

4. A machine as in claim 1, wherein, the means to attach the blade to the blade support bracket comprises connective devices passing through corresponding holes both in the blade and the blade support bracket.

5. A machine as in claim 1, wherein, the blade and the blade support bracket each comprise a plurality of holes such that the blade and the blade support bracket may be positioned such that different combinations of holes in the blade and the blade support bracket may be aligned enabling the angle between the blade and the blade support bracket to be changed and and/or enabling the length of the blade extension beyond an edge of the blade support bracket to be varied.

6. A machine as in claim 1, wherein, the blade support bracket comprises a blade support sleeve having a channel through which the blade may be slidably adjusted.

7. A method of edging a sodded sward comprising.
(a) attaching a blade support bracket/blade assembly to a lawn mower,
(b) positioning said blade support bracket/blade assembly such that the blade will contact uncut grass as the lawnmower is propelled about, and
(c) propelling the lawn mower to move such that the blade assembly is drawn through grass that a user desires to neatly edge.
